(19) United States
(12) Patent Application Publication
(10) Pub. No.: US 2008/0203095 A1
(43) Pub. Date: Aug. 28, 2008

(54) VAPOR-GUIDING LID FOR COOKWARE

(76) Inventor: Francesco Magno, Montreal (CA)

Correspondence Address: INVENTARIUM, Suite 1607, 4050 Rosemont, Montreal, QC, H1X1M4, CA

(21) Appl. No.: 12/033,030

(22) Filed: Feb. 19, 2008

Related U.S. Application Data
(60) Provisional application No. 60/902,515, filed on Feb. 22, 2007.

(51) Int. Cl. B65D 51/16; A47J 27/00

(52) U.S. Cl. 220/367.1; 220/573.1

(57) ABSTRACT

A vapor-guiding lid has a cover portion for removably covering an upper opening of a cookware the cover portion having an outer perimeter. The lid has a rigid canalized guiding member in fluid communication with the inside of the cookware to guide vapors out. The guiding member extending away from the cover portion and having an outlet located approximately at or past the outer perimeter of the cover portion for expelling the vapors.

### FIELD OF THE INVENTION

The present invention generally relates to cookware, and more particularly pertains to lids for covering pots and pans while guiding vapor away therefrom.

### BACKGROUND OF THE INVENTION

In the cooking industry, cookware such as pots, pans and other cooking vessels may be complemented by placing a lid on the top opening. Depending on their design, the lids may improve the cooking within the cookware and/or decrease spilling outside the cookware.

The prior art teaches various kinds of lids, which may have one or more openings for allowing steam or other vapors to be expelled. Depending on the arrangement of the openings, their size and their combination with other elements, the vapors within the cookware are expelled or re-condensed.

For instance, the U.S. Pat. Nos. 5,531,354, 2,510,196, 3,736,917, 4,285,441, 6,105,810, 6,105,811, 6,307,193, 6,669,047, 7,084,375, and United States patent application No. 2004/0144259 All describe various lids for cookware that enable venting, controlling the temperature or pressure, making a noise, or preventing spattering.

More particularly, U.S. Pat. No. 1,470,281 MOHLMAN describes a frying and roasting pan cover comprising hood vents, each having the shape of a half horn. The vapor is able to flow through the openings and out the end opening of the half horn vents. This allows the steam to escape in a certain direction and at the same time prevents grease from spattering above the cover.

U.S. Pat. No. 2,138,412 TREFEZ et al. describes a pressure controlling device for use with a lid. This pressure controlling device is a small cylindrical body extending from the curved surface of the lid of the pressure cooking vessel. The cylindrical body is canalized, having a pipe communicating with the interior of the cooking vessel. There are a number of openings in the pipe which, by rotating the internal head of the cylindrical body, may be brought into “alignment” when pressure is created within the vessel. Pressure may thus be relieved when one or more openings are brought into communication with the atmosphere; thus allowing steam to be expelled.

U.S. Pat. No. 5.551.702 BOSTON describes an indoor/outdoor grill and fry cooker having a generally bell-shaped cover which includes an exhaust opening. This exhaust opening extends obliquely from the curved cover and has an associated line.

The cookware lids shown in the prior art are able to expel vapors but present a variety of disadvantages that would be well known to a person skilled in the art.

For instance, when cooking in a domestic kitchen, steam and other vapors may rise from the cooking area. It has been useful to provide a fume hood, ventilation fan and/or vapor-collecting apparatus in proximity to the cooking area to avoid undesirable condensation of the vapors on surrounding items such as cabinets, furniture and even the cook himself. However, in many kitchens, the fume hood or ventilation fan does not sufficiently cover the area above the cookware to properly collect the expelled vapors.

Clearly, there is a need in the field of lids for cookware to address the problems and disadvantages of the prior art.

### SUMMARY OF THE INVENTION

Accordingly, the present invention addresses such a need by providing a vapor guiding lid having a cover portion for removably covering an upper opening of a cookware, the cover portion having an outer perimeter. The lid also comprises at least one rigid canalized guiding member. Each rigid canalized guiding member is in fluid communication with the inside of the cookware to guide vapors therefrom, the guiding member extending away from the cover portion and having an outlet located at or past the outer perimeter of the cover portion for expelling the vapors.

The canalized guiding member is able to guide the vapors, such as steam or smells, away from the cookware and toward an appropriate location, such as toward a fume hood, thereby enabling a much greater amount of vapor to be aspirated into the fume hood, hence greatly decreasing the amount of undesirable condensation on surrounding items and diffusion throughout the kitchen.

The cover portion has a plurality of concentric ridges which correspond to standard pots and pans diameters and allow the lid to fit over a variety of pots and pans sizes.

In a preferred embodiment, the rigid canalized guiding member consists of a cylindrical pipe extending obliquely upwards away from the cover portion.

Alternatively, the rigid canalized guiding member consists of a cylindrical pipe of 4″ to 6″ in length for some applications or 1″ to 4″ in length for other applications.

The rigid guiding member can be made out of steel, glass or other such rigid material. In some embodiments, the lid has a handle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Side elevation of the invention in context of use.

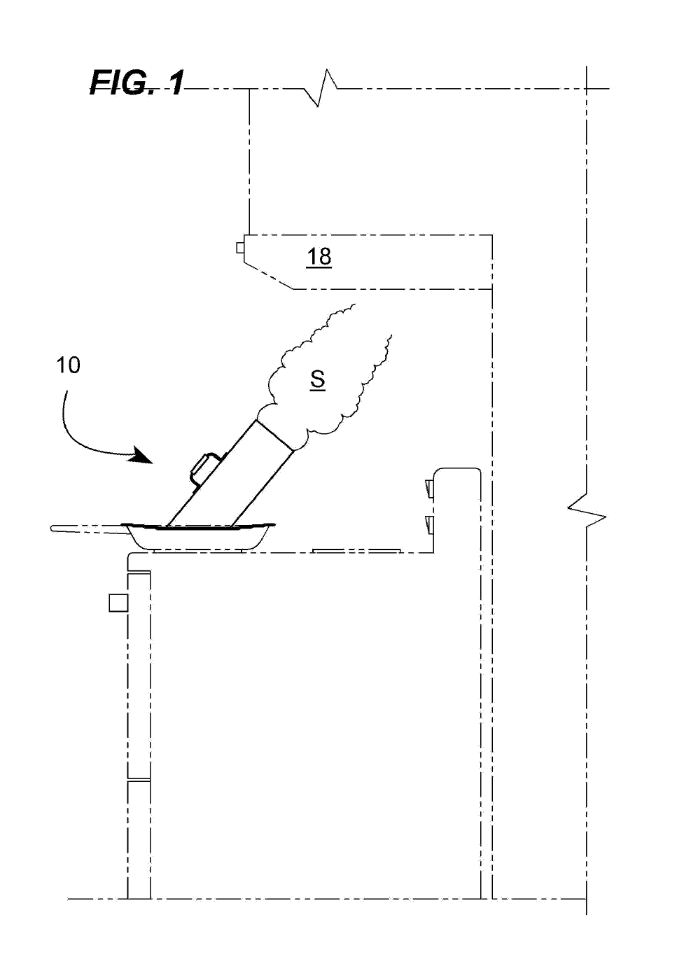

FIGS. 2a-b Top and side views, respectively of the invention installed on a pan.

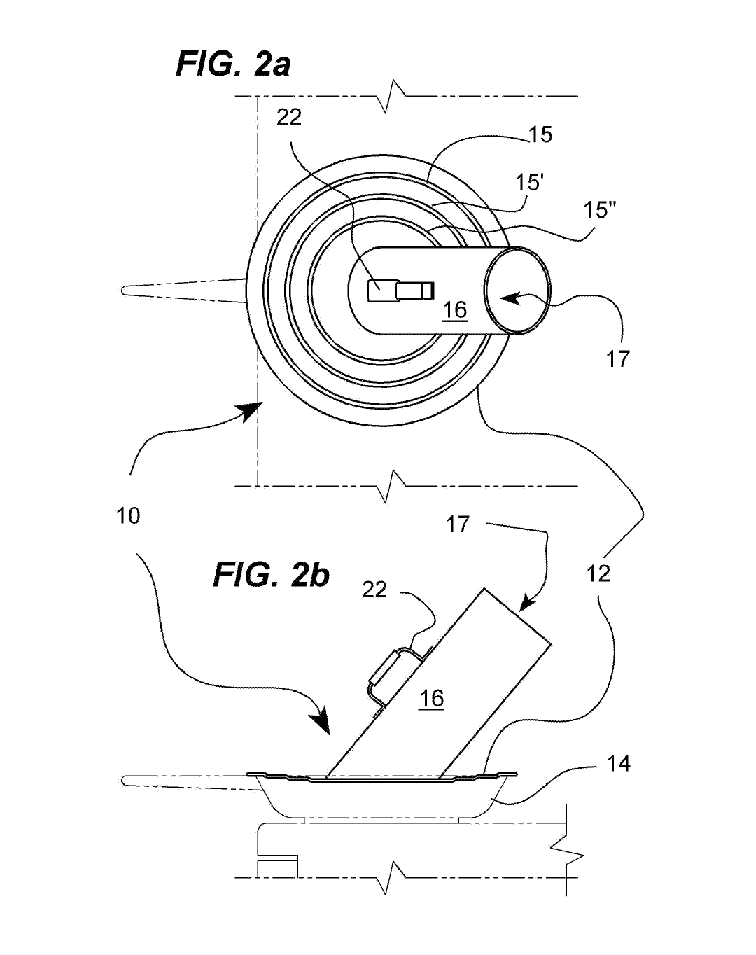

FIGS. 3a-c Side views of different sizes of pans used with the invention.

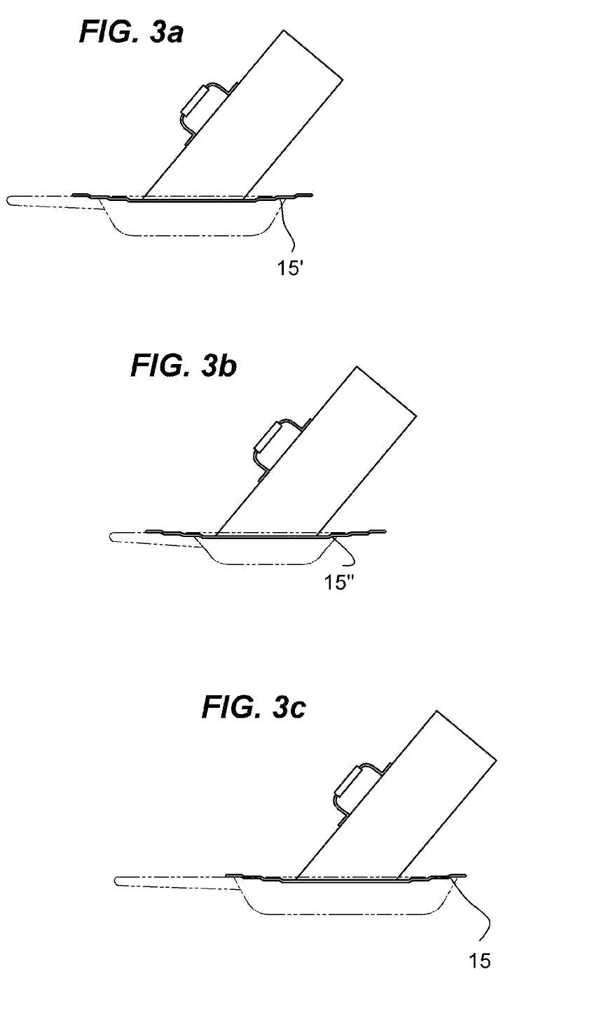

### DETAILED DESCRIPTION

A vapor-guiding lid 10 includes a cover portion 12 for removably covering the upper opening of a pot 14 to create a cooking cavity therebetween.

It should be understood that the cover portion 12 may have a variety of shapes. For example, the cover portion 12 may be dome-shaped, bell-shaped, but may also have a substantially flat shape, depending on the desired cooking operation or design of the lid 10. The cover portion has a plurality of concentric ridges 15, 15′, 15″ which correspond to standard pots and pans diameters and allow the lid 10 to fit over a variety of pots and pans sizes.

A rigid canalized guiding member 16 is secured to the cover portion 12 and is in fluid communication with the cooking cavity. The guiding member 16 has an outlet 17 located approximately at or past the outer perimeter of the cover portion 12. Preferably, the guiding member 16 extends just past the outer perimeter of the cover portion 12, but may also extend further.

It should be understood that the canalized guiding member 16 may take on a variety of shapes, lengths, widths and arrangements, which will be further discussed hereinbelow.

The steam contained beneath the cover portion 12 is forced to flow out through the rigid canalized guiding member 16, thus being guided away from the pot 14 and cover portion 12, and is expelled as released steam S. Indeed, the lid 10 is particularly useful in expelling steam.

The outlet 17 of the rigid guiding member 16 is preferably oriented so that the released steam S is guided so as to flow toward a fume hood 18.

It should be understood that the vapor-guiding lid 10 according to the present invention greatly improves guiding steam during cooking. In cooking operations, there is very often a fume hood 18 arranged either directly above the cookware or adjacent thereto, for collecting smells, steam and other vapors and removing them from the cooking area. There are a number of different types of ventilation fans useful for aspirating vapors, and may be arranged on a wall, as a hood above the cooking area, or in a variety of other ways known to a person skilled in the art.

Preferably, the rigid canalized guiding member 16 consists of a cylindrical pipe extending obliquely upwards away from the cover portion 12. For domestic kitchen applications in which water is boiled for pasta or potatoes, the pipe 16 is preferably about 4″ to 6″ in diameter to allow enough steam to be expelled. For smaller or less aggressive applications, the pipe 16 is preferably 1″ to 4″ in diameter. Alternatively, the guiding member 16 may have another form or diameter, depending on the application e.g. frying, sauce reductions, etc..

As mentioned hereinabove, the guiding member 16 has an outlet 17 located past the outer perimeter of the cover portion 12. This arrangement allows a number of advantages, as for example greater surety in the direction of the expelled steam, increased range for expelling vapors and the capacity to expel vapors far enough so as to decrease the damaging effects the may thus cause. Indeed, the vapors are expelled away from the cooking area and preferably toward a fume hood 18. This location of the outlet 17 also allows the vapors to be expelled away from the immediate cooking area irrespective of the flow rate of the vapors, which may be quite advantageous at various stages of the cooking process.

Furthermore, the rigid guiding member 16 is preferably oblique so as to guide the vapors along a certain vector to expel them in a preferred fashion, that is, toward the inlet of an overhanging fume hood 18 and/or away from an open space such as the middle of the kitchen, hence increasing the vapor removal and decreasing the potential harm and nuisance of the vapors.

The guiding member 16 is rigid to enable it to properly guide the steam in the desired direction and to expel it in an advantageous fashion. Its rigidity is due to its material of construction, which may be steel, glass or another heat-resistant material. Its rigidity also ensures that the outlet 17 location may be assured. Preferably, the cover portion 2 also has a handle 22.

A number of advantages arise from the vapor-guiding lid 10, some of which will be discussed hereinbelow. By preventing the steam and vapors from rising and condensing on cabinets, it is possible to avoid excessive cleaning and wiping of the condensed steam and oils. It is also possible to avoid long term damage of cabinets. By avoiding unwanted spills onto the stove and unwanted vapor condensation around the kitchen, cooking operations may be performed more efficiently. By avoiding increased humidity in the kitchen, the environment is also much more comfortable for the cook. It is also possible to greatly decrease the smells from cooking from permeating throughout the kitchen and the house. Sometimes, humidity and other forms of vapor should not be inhaled by humans, and thus the lid 10 may give rise to health benefits.

This vapor-guiding lid 10 greatly improves cooking while making it a more pleasurable and comfortable experience for the cook and helping to protect items in the kitchen. Efficiency and economic benefits of this invention are numerous and will be clear to a person skilled in the art.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, the shape of the cover portion 12 as well as the length, diameter, and shape of the vapor-guiding member 16 may be modified by a person skilled in the art to adapt to various cooking and design considerations.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A vapor-guiding lid comprising:
a cover portion for removably covering an upper opening of a cookware the cover portion having an outer perimeter;
the lid comprising a rigid canalized guiding member in fluid communication with the inside of the cookware to guide vapors out therefrom;
the guiding member extending away from the cover portion and having an outlet located approximately at or past the outer perimeter of the cover portion for expelling the vapors.

2. A vapor-guiding lid as in claim 1 wherein:
the cover portion has a plurality of concentric ridges which correspond to standard pots and pans diameters and allow the lid to fit over a variety of pots and pans sizes.

3. A vapor-guiding lid as in claim 1 wherein:
the rigid canalized guiding member consists of a cylindrical pipe extending obliquely upwards away from the cover portion.

4. A vapor-guiding lid as in claim 3 wherein:
the rigid canalized guiding member consists of a cylindrical pipe of 4″ to 6″ in length.

5. A vapor-guiding lid as in claim 3 wherein:
the rigid canalized guiding member consists of a cylindrical pipe of 1″ to 4″ in length.

6. A vapor-guiding lid as in claim 1 wherein:
the guiding member is made out of steel.

7. A vapor-guiding lid as in claim 1 wherein:
the guiding member is made out of glass.

8. A vapor-guiding lid as in claim 1 wherein:
the lid has a handle.
